(19) United States
(12) Patent Application Publication
(10) Pub. No.: US 2018/0078042 A1
(43) Pub. Date: Mar. 22, 2018

(54) Fishing Chair

(71) Applicants: Andrew Lentz, (US); Andrea Hankins, (US)

(72) Inventor: Andrew Lentz, Wichita, KS (US)

(73) Assignees: Andrew Lentz, Wichita, KS (US); Andrea Hankins, Wichita, KS (US)

(21) Appl. No.: 15/826,096

(22) Filed: Nov. 29, 2017

Related U.S. Application Data
(60) Provisional application No. 62/429,609, filed on Dec. 2, 2016.

(51) Int. Cl. A47C 7/00; A47C 1/14; A01K 97/00; A47C 4/28

(52) U.S. Cl. CPC A47C 7/008; A47C 4/28; A01K 97/00; A47C 1/14

(57) ABSTRACT

A chair for fishing alternatively upon a pier and a pond bank, the pond bank being sloped at an angle with respect to the pier, the chair including a seat; left and right legs which are fixedly attached to and extend downwardly from the front end of the seat; left and right quills which are fixedly attached to and extend downwardly from the rear end of the seat, wherein the extensions of the left and right legs are greater than the extensions of the left and right quills; wherein the stems have lower ends, wherein the stems are received within the quills, wherein the quills and stems are adapted for, upon the pier fishing extending the stems' equally with respect to the legs' extension and for, upon pond bank fishing, retracting the stems until the legs' and stems' lower ends are a plane sloped at the angle.

### FILED PROVISIONAL PATENT APPLICATION

This non-provisional patent application claims the benefit of and priority from U.S. Provisional Patent Application No. 62/429,609 filed Dec. 2, 2016. The inventor and applicant disclosed in said provisional application are the same as the inventor and applicant of the instant application. Structures and functions of structures disclosed and described in the instant application are substantially identical to those disclosed in said provisional application.

### FIELD OF THE INVENTION

This invention relates to chairs, benches, stools, and the like which are adapted for use during fishing. More particularly, this invention relates to such seating implements which are specially adapted for fishing upon the sloped banks of rivers, streams, and lakes.

### BACKGROUND OF THE INVENTION

Fishermen commonly fish from the banks of rivers, streams, and lakes, and such banks commonly include varyingly sloped ground surfaces. Upon placement by a fisherman of a folding chair upon such sloped river or lake bank, the chair's seat typically slopes downwardly toward the lake or stream, such slope causing the seat to be unstable and uncomfortable.

The instant inventive fisherman's chair solves or ameliorates the above described problems and deficiencies of folding chairs by specially adapting the legs of such chair for seat leveling with respect to a sloped stream bank or lake bank.

### BRIEF SUMMARY OF THE INVENTION

The instant inventive fishing chair preferably comprises a seat portion which extends substantially horizontally, and a back portion which extends substantially perpendicularly upwardly from a rearward end of the seat portion. Left and right front legs are provided, such legs respectively extending their lower ends equidistantly downwardly and preferably slightly forwardly from left and right ends of the front end of the chair's seat portion. Left and right rear legs similarly extend downwardly from left and right rear ends of the rear end of the seat. In a preferred embodiment, the instant inventive fishing chair further comprises left and right arm rests. The seat, the back, the arm rests, and the legs are preferably hingedly interconnected to allow the chair to be compactly folded.

In accordance with the instant invention, each of the fishing chair's left and right rear legs is specially adapted for selective telescoping extensions and retractions. In a preferred embodiment, the chair's left and right rear legs comprise quill and stem combinations wherein the quill portions have lower ends and preferably extend equidistantly downwardly from the rear end of the seat. In the preferred embodiment, the downward extensions of the lower ends of the quills are less than those of the lower ends of the legs. In the preferred embodiment, the quills are internally helically threaded, and the stem portions received within the quills are externally helically threaded. Suitably, the stem portions may be alternatively configured to include smooth walled hollow bores which nestingly receive smooth walled slide shafts. Such combinations' slide shafts may be selectively locked at or released from desired downward extensions by means of bore mounted “V” spring pin and alignable eyes combinations. Suitably, such leg extension and retraction may be effected by a screw actuated collet clamp.

In use of the instant inventive fishing chair, and assuming that the chair is to be utilized at a location such as a substantially level fishing pier, and also assuming that the preferred screw adapted quill and shaft combinations are provided at the chair's left and right rearward legs, a fisherman may initially turn the chair's screw shafts clockwise or counter-clockwise to upwardly or downwardly extend the feet of the chair's rearward legs to an elevation underlying the seat by approximately 18″. Upon such downward extensions of the lower ends of the stem portions, the lower ends of the front and rear legs preferably reside at a substantially common elevation beneath the seat. Thereafter, the fisherman may be seated upon the chair while the chair functions as a normal and conventional level surface seat.

In the event that the fisherman moves the chair from such level surfaced pier to an adjacent sloped lake bank, the fisherman may manually turn the chair's threaded quill components or screw shafts clockwise until the slope of a plane including the chair's four feet substantially matches the slope of the bank. Thereafter, the fisherman may be seated at the sloped pond bank upon the substantially leveled chair seat for stable and comfortable fishing.

Accordingly, objects of the instant invention include the provision of a fishing chair which incorporates structures as described above and which arranges those structures in relation to each other in manners described above for the performance of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of the instant inventive fishing chair.

FIG. 2 is a partial sectional view as indicated in FIG. 1.

FIG. 3 is a side view of the structure of FIG. 1.

FIG. 4 redepicts the structure of FIG. 2, the view alternatively showing the fishing chair configured for sloped bank fishing.

FIG. 5 presents an alternative configuration of the structure of FIG. 2.

FIG. 6 presents a further alternate configuration of the structure of FIG. 2.

### DETAILED DESCRIPTION OF PREFERRED EMBODIMENTS

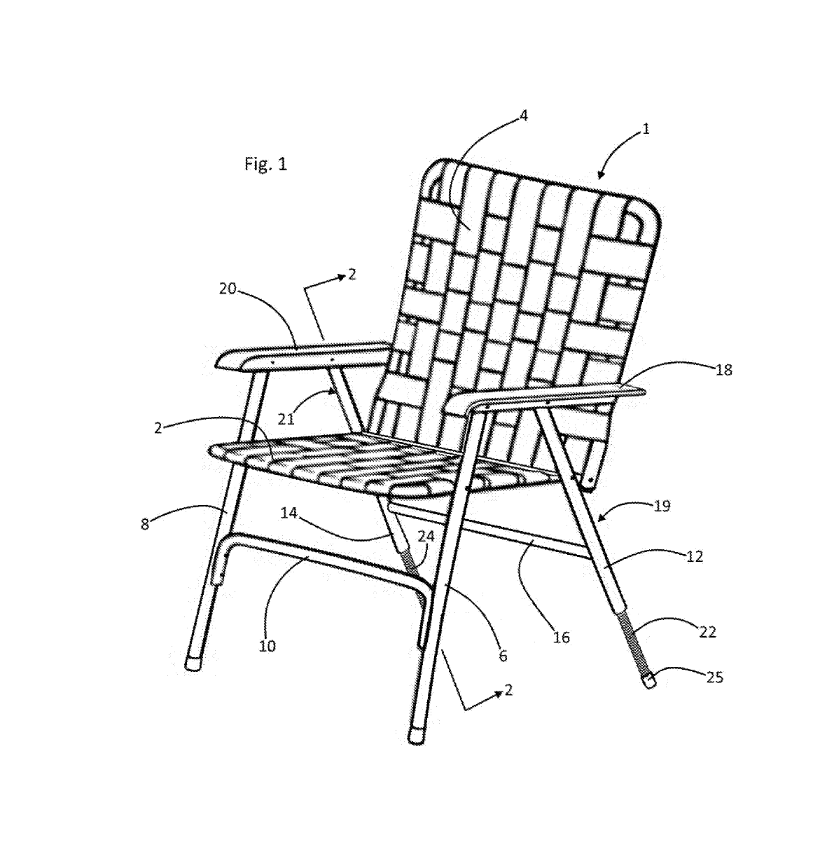

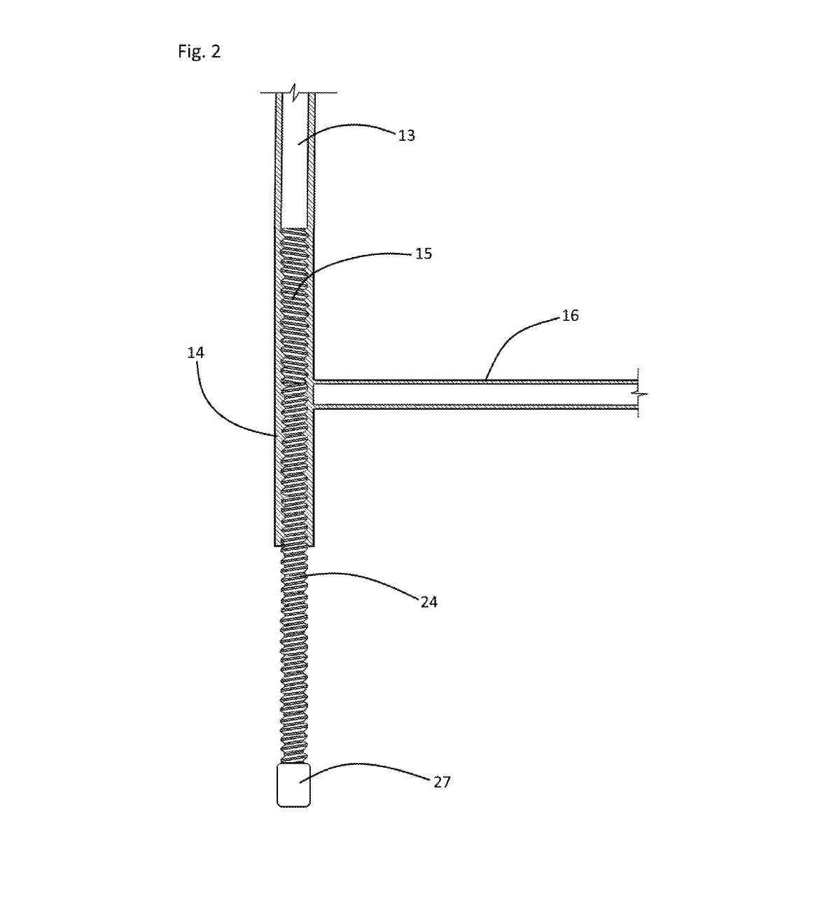

Referring now to the drawings and in particular, simultaneously to FIGS. 1-4, a preferred embodiment of the instant inventive fishing chair is referred to generally by Reference Arrow 1. The fishing chair 1 has a substantially level seat 2 and a chair back 4 extending substantially perpendicularly upwardly from the rearward end of the seat 2. Left and right front legs 6 and 8 are fixedly and pivotally attached to forward ends of left and right arm rests 18 and 20 and to the left and right edges of the forward end of the chair seat 2.

The chair's rear left and right legs are referred to generally by

Reference Arrows 19 and 21. The upper ends 12 and 14 of the chair's rearward legs 19 and 21 are preferably tubularly configured for function as quill portions of left and right quill and stem combinations. Accordingly, the left and right legs 19 and 21 preferably comprise telescoping quill and stem combinations which are adapted for telescoping chair leveling use. In the FIGS. 1-4 embodiment, the hollow bores 13 of legs' quill portions 12 and 14 have internal helical threads 15, such threads being fitted for threaded receipt of helically threaded stems or shafts 22 and 24.

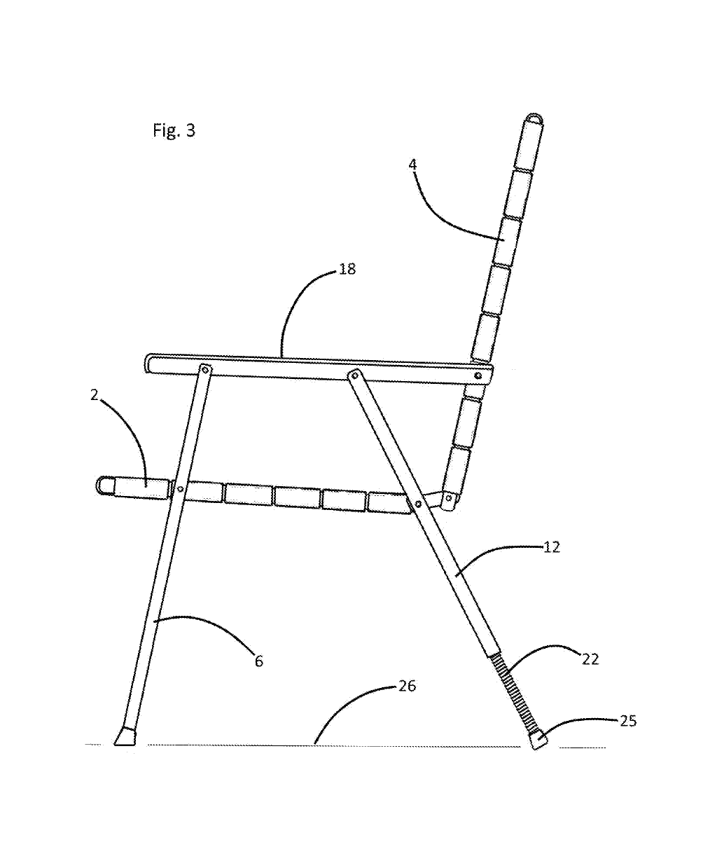

In use of the inventive fishing chair 1, referring in particular to FIGS. 1 and 3, the chair may be utilized upon a level surface 26, such as that of a fishing pier. To accommodate such level surface use, a fisherman may grasp chair foot 25 and may turn the threaded shaft 22 counter-clockwise until such shaft extends downwardly from the internally helically threaded quill portion 12, such extension providing an effective leg length of approximately 18″, such length substantially matching that of the front legs 6 and 8. Thereafter, the right threaded shaft 24 may be similarly manipulated. Thereafter, the fisherman may be seated upon seat 2 for level surface fishing upon the pier.

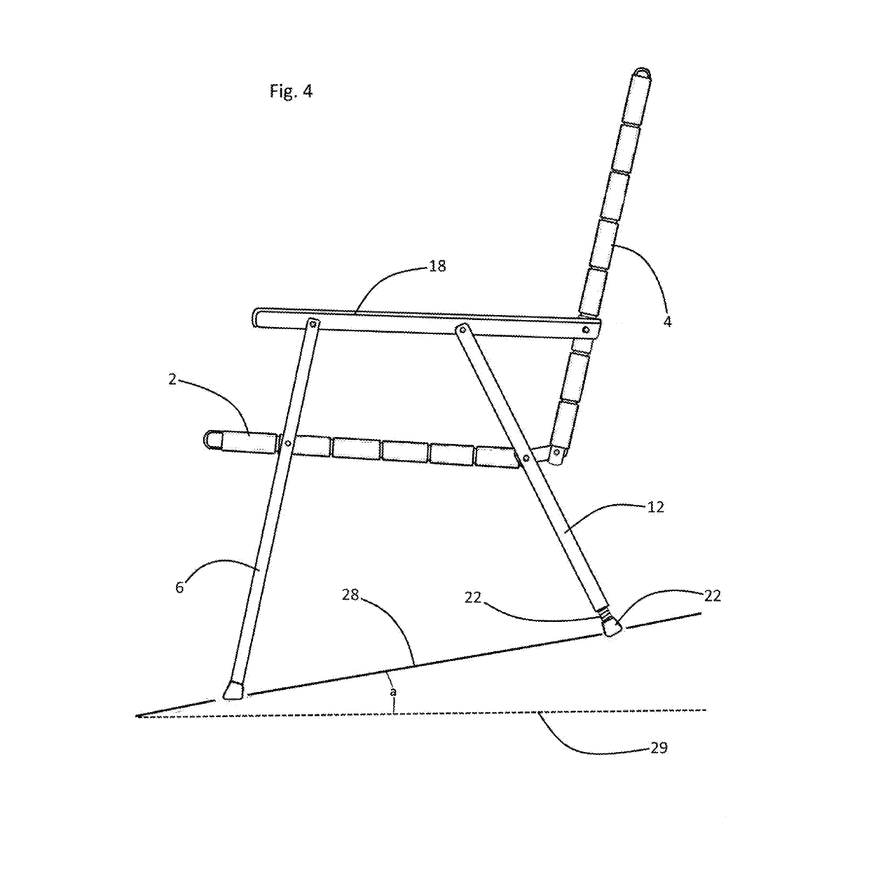

Referring simultaneously to FIGS. 3 and 4, upon movement of the chair 1 from such fishing pier surface 26 to a lake bank 28 which slopes at an angle “a” from horizontal 29 (and with respect to the surface 26 of the pier), the fisherman may grasp chair foot 25 to turn threaded shaft 22 clockwise, causing such shaft to upwardly retract within the tubular internally helically threaded quill portion 12. The left helically threaded shaft 24 may be similarly manipulated. Thereafter, the fisherman may be seated upon seat 2 and may fish comfortably therefrom at the bond bank 28 just as though the chair 1 were resting upon the level pier surface 26.

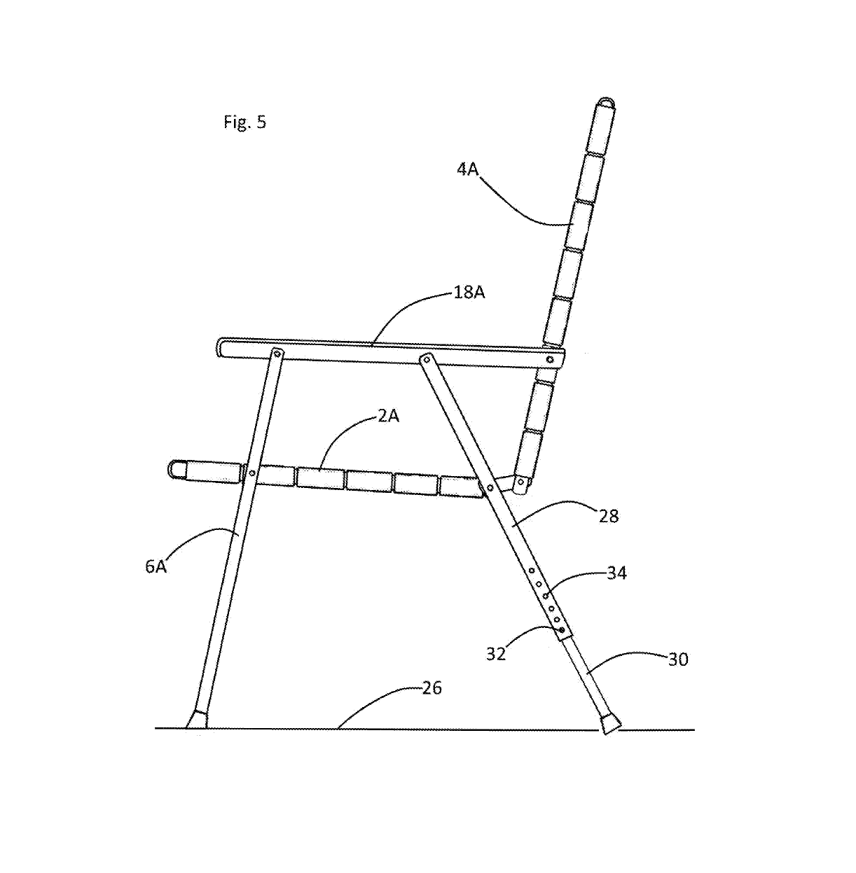

Referring to FIG. 5, each structure identified by a reference numeral having a suffix “A” is configured substantially with similarly numbered structures appearing in FIGS. 1-4. In the FIG. 5 structural alternative, the rear leg quill and stem combinations comprise a smooth bored quills 28 which nestingly and telescopingly receive smooth walled stem portions 30. Finger depressible “V” spring biased pins 32 may be inwardly depressed to allow the slide shafts 30 to selectively move slidably upwardly and downwardly within the quill portions 28. Upon sliding movement of the pins 32 to selected laterally paired eyes 34, the pins 32 may relock the chair's rear legs at a desired extended or retracted position.

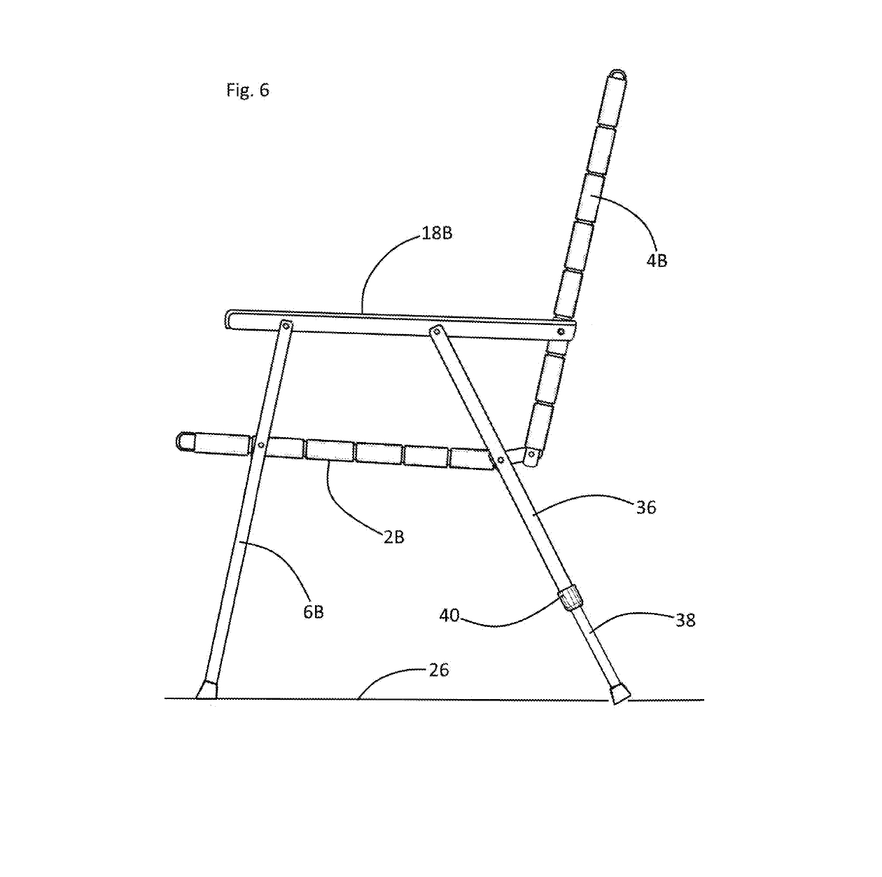

In the FIG. 6 alternative, all structures identified with a reference numeral having the suffix “B” are configured substantially identically with similarly numbered structures appearing in FIGS. 1-4.

In the FIG. 6 alternative, smooth bored quill portions 36 slidably receive smooth walled stem portions 38, while a screw actuated collet clamp 40 selectively releases or locks the stem portion 38 for movement to desired leg extensions, or for locking the legs at such extensions.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1. A chair for fishing alternatively upon a substantially horizontal pier and upon a pond bank, the pond bank being sloped at an angle “a” with respect to said pier, said chair comprising:
(a) a seat having front and rear ends;
(b) left and right legs having lower ends, the left and right legs being fixedly attached to and extending downwardly from the front end of the seat;
(c) left and right quills having lower ends, the left and right quills being fixedly attached to and extending downwardly from the rear end of the seat, wherein the downward extensions of the left and right legs are greater than those of the left and right quills;
(d) left and right stems having lower ends, the left and right stems being respectively received within the left and right quills, wherein the quills and stems are adapted for, upon the pier fishing extending the stems' lower ends equidistantly with respect to the front legs' extensions, and for, upon the pond bank fishing, retracting the stems' lower ends until the legs' and stems' lower ends reside in a plane oriented at the angle “a”.

2. The chair of claim 1 wherein the left and right quills are internally helically threaded, and wherein the stems are externally helically threaded.

3. The chair of claim 2 further comprising a back fixedly attached to and extending upwardly from the seat's rear end.

4. The chair of claim 3 wherein the legs and quills have upward extensions, and further comprising left and right arm rests fixedly attached to said upward extensions.

5. The chair of claim 4 further comprising a plurality of hinged connections, each hinged connection residing at a juncture selected from the group consisting of leg and seat attachments, quill and seat attachments, arm rest and leg attachments, arm rest and quill attachments, seat and back attachments, and arm rest and back attachments.

6. The chair of claim 5 wherein the seat and back comprise woven strap matrices.

7. The chair of claim 6 further comprising a pair of front feet and a pair of rear feet, said feet pairs being respectively fixedly attached to the lower ends of the legs, and to the lower ends of the stems.
